(19) United States
(12) Patent Application Publication
(10) Pub. No.: US 2026/0187424 A1
(43) Pub. Date: Jul. 2, 2026

(54) Construction method of reduced-order neural operator on riemannian manifolds for unequal-domain mappings in spatio-temporal processes

(71) Applicant: Nanjing University of Aeronautics and Astronautics, Nanjing (CN)

(72) Inventors: Yingguang Li, Nanjing (CN); Xu Liu, Nanjing (CN); Qinglu Meng, Nanjing (CN); Shaochun Sui, Nanjing (CN); Gengxiang Chen, Nanjing (CN); Changqing Liu, Nanjing (CN); Xiaozhong Hao, Nanjing (CN); Zhiliang Deng, Nanjing (CN); Qiutong Wu, Nanjing (CN)

(73) Assignee: Nanjing University of Aeronautics and Astronautics, Nanjing (CN)

(21) Appl. No.: 19/315,351

(22) Filed: Aug. 1, 2025

(30) Foreign Application Priority Data
Aug. 29, 2024 (CN) 202411198809.X

(51) Int. Cl. G06N 3/049

(52) U.S. Cl. CPC G06N 3/049

(57) ABSTRACT

The invention discloses a construction method of a reduced-order neural operator on Riemannian manifolds for unequal-domain mappings in spatio-temporal processes, which belongs to the field of machine learning technology, including obtaining a set of basis functions for non-common domains of input functions and output functions, and then constructing the unequal-domain encoder/decoder; for the common domain of input function and output function, the neural operator on Riemannian manifolds are used to construct the domain mapping module. Finally, according to the type of unequal-domain mapping, the unequal-domain encoder or decoder is combined with the same-domain approximator to construct a reduced-order neural operator for unequal-domain mapping of spatio-temporal processes. The invention adopts the above-mentioned construction method of a reduced-order neural operator on Riemannian manifolds for unequal-domain mappings in spatio-temporal processes, and designs a general reduced-order manifold neural operator architecture according to the characteristics of unequal-domain mapping of spatio-temporal process, which can take into account both prediction accuracy and training efficiency.

### TECHNICAL FIELD

The invention relates to the field of machine learning technology, especially to a construction method of a reduced-order neural operator on Riemannian manifolds for unequal-domain mappings in spatio-temporal processes.

### BACKGROUND

spatio-temporal process refers to the process of evolution in time and space, many processes in the field of natural science and technical science belong to spatio-temporal process, such as the process controlled by time-varying partial differential equations, the process of climate change, the process of aortic blood flow and the curing process of composite materials. The spatio-temporal process involves three functions: temporal function ƒ(t), spatial function ƒ(x) and spatio-temporal function ƒ(x,t). The predictive learning of spatio-temporal processes refers to the construction of operator mappings between these three types of functions. There is an important class of unequal-domain mappings in the predictive learning of spatio-temporal processes: one of the input function and the output function is a spatio-temporal function, and the other is a time or spatial function. The two functions share the same temporal domain or spatial domain, which is called the common domain; another additional domain is called non-common domain. For example, for unequal-domain mapping a(x)→u(x,t), the common domain is the spatial domain, and the non-common domain is the temporal domain. Traditional numerical simulation methods have low computational efficiency for unequal-domain mapping in complex scenes or repeated computing scenes, while neural operators can effectively learn the mapping between function spaces by using deep learning methods, which can achieve rapid prediction once the training is completed.

The existing patents can refer to the Chinese patent with a publication number of CN116187386 A, which discloses a method for constructing neural operators on Riemannian manifolds for complex geometries, which can learn the mapping from function space defined on complex geometries to function space. The method works well on the same domain mapping problem, but the above technology still has defects: the domain of the input function and the output function must be the same. When dealing with unequal-domain mapping, additional domain expansion or domain reduction changes are required for the model. These operations can only ensure the formal feasibility of the model, and it is difficult to guarantee the prediction effect. In view of the above defects, it is necessary to provide a construction method of a reduced-order neural operator on Riemannian manifolds for unequal-domain mappings in spatio-temporal processes.

### SUMMARY

The purpose of the invention is to provide a construction method of a reduced-order neural operator on Riemannian manifolds for unequal-domain mappings in spatio-temporal processes to solve the problems existing in the above background technology.

In order to achieve the above purpose, the invention provides a construction method of a reduced-order neural operator on Riemannian manifolds for unequal-domain mappings in spatio-temporal processes, including the following steps:
S1, for a non-common domain of an input function and an output function, obtaining a set of temporal basis function φ(t) or spatial basis function φ(x);
S2, using the temporal basis function φ(t) or spatial basis function φ(x) obtained by S1 to construct an unequal-domain encoder E and an unequal-domain decoder D;
S3, for a common domain of the input function and the output function, using a neural operator on Riemannian manifolds to construct a same-domain approximator A;
S4, according to a type of the unequal-domain mapping, combining the unequal-domain encoder E or the unequal-domain decoder D with the same-domain approximator A to construct a reduced-order neural operator for unequal-domain mapping of spatio-temporal processes.

Preferably, in S1, for the non-common domain of the input function and the output function, the method of obtaining a set of temporal basis function φ(t) or spatial basis function φ(x) includes obtaining by using the modal decomposition method based on training data, such as intrinsic orthogonal decomposition and dynamic modal decomposition; the basis function that is independent of training data is directly used, such as the Laplace-Beltrami operator basis function in a spatial domain and the Fourier basis function in a temporal domain.

Preferably, in S2, the unequal-domain encoder E is to use the temporal basis function φ(t) or spatial basis function φ(x) to reduce an order of a spatio-temporal function ƒ(x,t) to a spatial weight function w(x) or a temporal weight function w(t).

Preferably, the unequal-domain decoder D in S2 reconstructs the corresponding spatial weight function w(x) or temporal weight function w(t) into a spatio-temporal function ƒ(x,t) by using a temporal basis function φ(t) or a spatial basis function φ(x).

Preferably, in S3, the neural operator on Riemannian manifolds used to construct the same-domain approximator A contains at least one of kernel integration modules, wherein a selection of the kernel integration module is divided into the following: if the common domain of the input function and the output function is the temporal domain, the Fourier basis function is used to construct the kernel integration module in the neural operator on Riemannian manifolds; if the common domain of the input function and the output function is a spatial domain, the kernel integral module in the neural operator on Riemannian manifolds is constructed by using eigenfunctions of the Laplace-Beltrami operator.

Preferably, in S4, according to the type of unequal-domain mapping, the unequal-domain encoder E or the unequal-domain decoder D is combined with the same-domain approximator A to construct a reduced-order neural operator for unequal-domain mapping of spatio-temporal processes, including two cases:
in the first case, if the input function is a spatio-temporal function, an architecture of the reduced-order neural operator is input function-unequal-domain encoder E-same-domain approximator A-output function;
in the second case, if the output function is a spatio-temporal function, the architecture of the reduced-order neural operator is: input function-same-domain approximator A-unequal-domain decoder D-output function.

Therefore, the invention adopts the above-mentioned reduced-order neural operator on Riemannian manifolds for unequal-domain mappings in spatio-temporal processes, which has the following beneficial effects compared with the existing technology:

By using the constructed unequal-domain encoder or unequal-domain decoder, the unequal-domain mapping is reduced to an equivalent domain mapping, so that the neural operator on Riemannian manifolds can be directly applied without additional domain expansion or domain reduction changes to the model, and the prediction effect is more stable. And because of the introduction of the reduced-order idea, the training efficiency is faster.

The following is a further detailed description of the technical scheme of the invention through drawings and implementation examples.

### BRIEF DESCRIPTION OF THE DRAWINGS

FIG. 1 is s flow chart of the invention;

FIG. 2 is a schematic diagram of the reduced-order neural operator containing the same-domain approximator and the unequal-domain decoder in the embodiment of the invention.

FIG. 3 shows the comparison between the true value and the predicted value of this method at four typical moments of a set of test data in the embodiment of the invention.

### DETAILED DESCRIPTION OF THE EMBODIMENTS

### Embodiment

In order to make the purpose, technical scheme and advantages of the embodiment of the invention more clear, the following will describe the technical scheme of the embodiment of the invention clearly and completely in combination with the attached figure of the embodiment of the invention. Obviously, the described embodiment is part of the embodiment of the invention, not all of the embodiments. The components of the embodiment of the invention, usually described and shown in the accompanying figure, can be arranged and designed in various configurations.

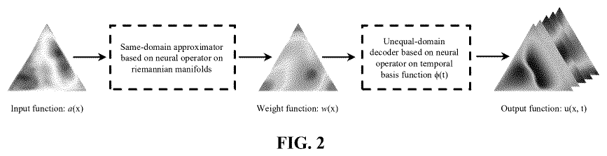

This embodiment takes the solution of the two-dimensional Burgers equation shown in FIG. 2 as an example; the input is the initial velocity field a(x), which is a spatial function, and the output is the internal velocity field u(x,t) in t∈ [0.05,5], which is a spatio-temporal function, it is a typical unequal-domain mapping. Where, the number of discrete temporal domain is nₜ}=100, the number of discrete spatial domain is nₓ=415. In this embodiment, 3000 sets of function pairs of

$${\{ ( {a}_{i} , {u}_{i} ) \}}_{i = 1}^{3000}$$

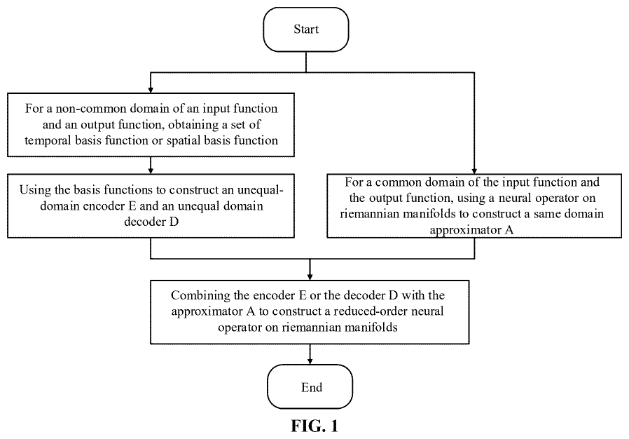

are obtained as training data and 500 sets of function pairs as test data by numerical simulation method. In this embodiment, as shown in FIG. 1, a construction method of the reduced-order neural operator on Riemannian manifolds for unequal-domain mappings in spatio-temporal processes, including the following steps:

S1, for the non-common domain of the input function and the output function, obtain a set of temporal basis functions or spatial basis functions;

for a non-common domain of the input function and the output function, a set of temporal basis function φ(t) or spatial basis function φ(x) is obtained;

in this embodiment, the non-common domain of the input function and the output function is the temporal domain, so a set of temporal basis functions needs to be obtained, based on 3000 sets of training data, the first 32 modes in the temporal domain are obtained by using the intrinsic orthogonal decomposition calculation as a set of temporal basis function Φ∈R^{32×nt}.

S2, the temporal basis function or spatial basis function obtained by S1 are used to construct an unequal-domain encoder E and an unequal-domain decoder D;

in this example, an unequal-domain decoder that uses a set of temporal basis function φ∈R^{32×nt} to transform a spatial function W∈R^{nx×32} into a spatio-temporal function ƒ∈R^{nx×nt}, which is denoted as D:R^{nx×32}→R^{nx×nt}.

S3, or the common domain of input function and output function, the neural operator on Riemannian manifolds containing at least one of kernel integration modules is used to construct the same-domain approximator A.

In this example, the neural operator on Riemannian manifolds with four kernel integral modules is used to construct the same-domain approximator, and since the common domain of the input function and the output function is a spatial domain, the kernel integral module is constructed by using the eigenfunction of the Laplace-Beltrami operator. Each kernel integral module contains a frequency domain transform sub-module, a linear transform sub-module and a nonlinear activation sub-module. The frequency domain transform sub-module includes: (1) The input function of the sub-module is reduced by using the first 128 eigenfunctions of Laplace-Beltrami operators, and the coefficient vector with dimension of 128 is obtained. (2) Linear transformation of the 128-dimensional coefficient vector; (3) The eigenfunctions of the first 128 Laplace-Beltrami operators are used to reconstruct the coefficient vector after linear transformation, and the sub-module output function is obtained. The nonlinear activation sub-module uses the gelu activation function. In this embodiment, in order to enhance the learning ability of the neural operator on Riemannian manifolds, a fully connected neural network with a layer of 64 neurons is set before the four kernel integration modules, and a two-layer fully connected neural network is set after the four kernel integration modules. The number of neurons in each kernel integration module is 32, and the fully connected layer uses the gelu activation function. The same-domain approximator finally outputs the spatial weight function.

S4, according to the type of the unequal-domain mapping, the unequal-domain encoder E or the unequal-domain decoder D is combined with the same-domain approximator A to construct a reduced-order neural operator for unequal-domain mapping of spatio-temporal processes.

In this example, because the output function is a spatio-temporal function, the unequal-domain decoder constructed in S2 and the same-domain approximator constructed in S3 are used to construct the reduced-order neural operator. The specific architecture from the input function to the output function is: input function a∈R^{nx×1} same-domain approximator A-spatial weight function w∈R^{nx×32}-unequal-domain decoder D-output function u∈R^{nx×nt}.

In this embodiment, 3000 sets of function pairs

$${\{ ( {a}_{i} , {u}_{i} ) \}}_{i = 1}^{3000}$$

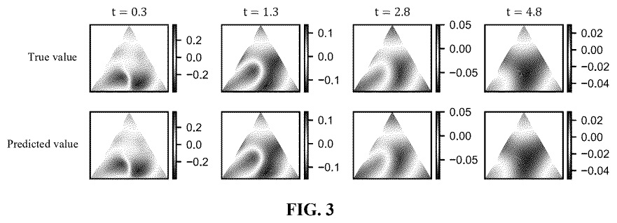

are obtained as training data and 500 sets of function pairs as test data by numerical simulation method. Using the classical neural network training method, the batch size is 50, the learning rate is 0.01 (100 times per iteration, the learning rate decays by 50%), the optimizer is Adam, and the loss function is defined as follows:

$$Loss = \frac{1}{N} {\sum }_{n = 1}^{N} \frac{{‖ {y}_{i} - {y}_{pi} ‖}_{{L}^{2}}}{{‖ {y}_{i} ‖}_{{L}^{2}}}$$

Where N denotes the number of training data, yᵢ denotes the true value of the velocity field, and yₚᵢ denotes the predicted value of the velocity field is represented. After 500 iterations of training, the test error on 500 sets of test data is 4.356%. As shown in FIG. 3, the comparison between the true value and the predicted value of this method at four typical moments of a set of test data is given. It can be seen that according to the method of the invention, a reduced-order neural operator for non-equidomain mapping of spatio-temporal processes can be constructed, and the prediction accuracy is higher.

Therefore, the invention adopts the above-mentioned construction method of a reduced-order neural operator on Riemannian manifolds for unequal-domain mappings in spatio-temporal processes, including a unequal-domain encoder, an unequal-domain decoder, and a reduced-order neural operator architecture for unequal-domain mapping of spatio-temporal processes. Compared with the existing technology, its prediction accuracy is higher, and it can also take into account the training efficiency.

Finally, it should be explained that the above embodiment is only used to explain the technical scheme of the invention rather than restrict it. Although the invention is described in detail with reference to the better embodiment, the ordinary technical personnel in this field should understand that they can still modify or replace the technical scheme of the invention, and these modifications or equivalent substitutions cannot make the modified technical scheme out of the spirit and scope of the technical scheme of the invention.

What is claimed is:

1. A construction method of a reduced-order neural operator on Riemannian manifolds for unequal-domain mappings in spatio-temporal processes, comprising the following steps:
S1, for a non-common domain of an input function and an output function, obtaining a set of temporal basis function φ(t) or spatial basis function φ(x);
S2, using the temporal basis function φ(t) or spatial basis function ¢ (x) obtained by S1 to construct an unequal-domain encoder E and an unequal-domain decoder D;
S3, for a common domain of the input function and the output function, using a neural operator on Riemannian manifolds to construct a same-domain approximator A;
S4, according to a type of the unequal-domain mapping, combining the unequal-domain encoder E or the unequal-domain decoder D with the same-domain approximator A to construct a reduced-order neural operator for unequal-domain mapping of spatio-temporal processes;
in S2, the unequal-domain encoder E is to use the temporal basis function φ(t) or spatial basis function φ(x) to reduce an order of a spatio-temporal function ƒ(x,t) to a spatial weight function w(x) or a temporal weight function w(t);
in S2, the unequal-domain decoder D reconstructs the corresponding spatial weight function w(x) or temporal weight function w(t) into a spatio-temporal function ƒ(x,t) by using a temporal basis function φ(t) or a spatial basis function φ(x);
in S3, the neural operator on Riemannian manifolds used to construct the same-domain approximator A contains at least one of kernel integration modules, wherein a selection of the kernel integration module is divided into the following: if the common domain of the input function and the output function is the temporal domain, the Fourier basis function is used to construct the kernel integration module in the neural operator on Riemannian manifolds; if the common domain of the input function and the output function is a spatial domain, the kernel integral module in the neural operator on Riemannian manifolds is constructed by using an eigenfunction of the Laplace-Beltrami operator;
in S4, according to the type of unequal-domain mapping, the unequal-domain encoder E or the unequal-domain decoder D is combined with the same-domain approximator A to construct a reduced-order neural operator for unequal-domain mapping of spatio-temporal processes, including two cases:
in the first case, if the input function is a spatio-temporal function, an architecture of the reduced-order neural operator is input function-unequal-domain encoder E-same-domain approximator A-output function;
in the second case, if the output function is a spatio-temporal function, the architecture of the reduced-order neural operator is: input function-same-domain approximator A-unequal-domain decoder D-output function.

2. The construction method of a reduced-order neural operator on Riemannian manifolds for unequal-domain mappings in spatio-temporal processes according to claim 1, wherein in S1, for the non-common domain of the input function and the output function, the method of obtaining a set of temporal basis function φ(t) or spatial basis function φ(x) comprising obtaining by using the modal decomposition method based on training data, such as intrinsic orthogonal decomposition and dynamic modal decomposition; the basis function that is independent of training data is directly used, such as the Laplace-Beltrami operator basis function in a spatial domain and the Fourier basis function in a temporal domain.
